(19) United States
(12) Patent Application Publication
(10) Pub. No.: US 2023/0407019 A1
(43) Pub. Date: Dec. 21, 2023

(54) INORGANIC MATERIAL-REINFORCED THERMOPLASTIC POLYESTER RESIN COMPOSITION AND METHOD FOR PRODUCING SAME

(71) Applicant: TOYOBO MC Corporation, Osaka (JP)

(72) Inventors: Takahiro SHIMIZU, Otsu-shi, Shiga (JP); Yoshitaka AYUZAWA, Otsu-shi, Shiga (JP)

(73) Assignee: TOYOBO MC Corporation, Osaka (JP)

(21) Appl. No.: 18/037,633

(22) PCT Filed: Nov. 15, 2021
(86) PCT No.: PCT/JP2021/041865

§ 371 Date: May 18, 2023

(30) Foreign Application Priority Data
Nov. 19, 2020 (JP) 2020-192763

(51) Int. Cl. C08J 5/04

(52) U.S. Cl. CPC C08J 5/043; C08J 2367/02; C08J 2467/02; C08J 2469/00

(57) ABSTRACT

An inorganic material-reinforced thermoplastic polyester resin composition from which a molding with high rigidity and high strength having less appearance defects such as floating of inorganic reinforcing material and less warp deformation and having a uniform textured appearance without irregularities can be obtained comprises specific amounts of a polybutylene terephthalate resin (A), a polyethylene terephthalate resin (B), a copolymerized polybutylene terephthalate resin (C), a copolymerized polyethylene terephthalate resin (D), a polycarbonate-based resin (E), a glass fiber-based reinforcing material (F), and a transesterification inhibitor (G), respectively, wherein glass fiber-based reinforcing material (F) comprises specific amounts of a flat cross-section glass fiber (F1) and a milled short glass fiber (F2), respectively, wherein glass fiber-based reinforcing material (F) in the resin composition has a weight average fiber length Lw of 200 to 700 μm, and wherein the inorganic material-reinforced thermoplastic polyester resin composition has a melt viscosity in a specific range.

### TECHNICAL FIELD

The present invention relates to an inorganic material-reinforced thermoplastic polyester resin composition containing a thermoplastic polyester resin and an inorganic reinforcing material such as glass fiber. Specifically, the present invention relates to an inorganic material-reinforced thermoplastic polyester resin composition from which a molding with high rigidity and strength having less appearance defects such as floating of inorganic reinforcing material, and having a uniform textured appearance without irregularities or a mirror surface appearance, can be obtained. Further, the present invention relates to an inorganic material-reinforced thermoplastic polyester resin composition having good fluidity and low burring properties even in forming a long and thin-walled molding.

### BACKGROUND ART

Generally, due to excellence in mechanical properties, heat resistance, chemical resistance, etc., polyester resins have been widely used for automobile parts, electric and electronic parts, household utensils, etc. In particular, a polyester resin composition reinforced with inorganic reinforcing material such as glass fiber allows the rigidity, strength and heat resistance to be drastically improved. It is known that the rigidity is improved particularly with the amount of inorganic reinforcing material added.

However, with increase in the amount of inorganic reinforcing material such as glass fiber added, the inorganic reinforcing material such as glass fiber tends to be floated on the surface of a molding. Accordingly, a molding which requires surface gloss may have a problem of decrease in surface gloss, and a molding with a matte surface may have a problem of textured appearance defect.

In particular, a polyester resin having a fast crystallization rate such as polybutylene terephthalate is very difficult to obtain a satisfactory appearance due to poor transferability to a mold resulting from crystallization during forming.

On the other hand, as a method for obtaining a good textured appearance, a method with use of isophthalic acid-modified polybutylene terephthalate or polycarbonate resin (for example, Patent Literature 1 and 2) has been proposed. However, in Patent Literature 1, with increase in the filling amount in order to obtain high mechanical strength or high rigidity, the appearance is damaged, and in Patent Literature 2, a large amount of isophthalic acid-modified polybutylene terephthalate or polycarbonate resin added is required, so that the forming stability and forming cycle are unsatisfactory.

In order to remedy these shortcomings, Patent Literature 3 has been proposed. However, there exist shortcomings therein including insufficient rigidity for use requiring high rigidity, deterioration of appearance along with increase in the amount of reinforcing material for enhancing the rigidity, and difficulty in stably obtaining good-quality products due to very narrow molding conditions.

In recent years, a molding tends to be thinner and longer, and further higher rigidity (bending modulus: more than 20 GPa) and appearance quality equal to or better than conventional ones are required. In order to achieve the quality balance, a polyester resin composition containing more than 60 mass % of glass fiber-based reinforcing material with use of a flat glass in combination with a milled fiber has been proposed in Patent Literature 4. However, variations in quality such as mechanical strength, appearance, warp, etc. are large, so that stabilization of quality has been an important problem.

### CITATION LIST

### Patent Literature

PTL 1: Japanese Patent Laying-Open No. 2007-92005
PTL 2: Japanese Patent Laying-Open No. 2008-120925
PTL 3: WO 2015/008831
PTL 4: Japanese Patent Laying-Open No. 2017-39878

### SUMMARY OF INVENTION

### Technical Problem

An object of the present invention is to provide an inorganic material-reinforced thermoplastic polyester resin composition from which a molding with high rigidity (bending modulus: more than 20 GPa) and high strength having less appearance defects such as floating of inorganic reinforcing material and less warp deformation and having a uniform textured appearance without irregularities can be obtained, allowing stable quality to be obtained with less variation in quality such as mechanical strength, appearance and warp even in a long-time production.

### Solution to Problem

Through extensive study of polyester resin composition constitution and property to solve the problem, the present inventors have completed the present invention based on the finding that the cause of variation in quality such as mechanical strength, appearance and warp in a long-time production relates to the length of glass fibers in a polyester resin composition, and the problem can be solved by controlling the fiber length to a specific range.

In other words, the present invention has the following constitution.

[1] An inorganic material-reinforced thermoplastic polyester resin composition, comprising 8 to 20 parts by mass of a polybutylene terephthalate resin (A), 1 to 7 parts by mass of a polyethylene terephthalate resin (B), 1 to 12 parts by mass of a copolymerized polybutylene terephthalate resin (C), 5 to 12 parts by mass of a copolymerized polyethylene terephthalate resin (D), 1 to 6 parts by mass of a polycarbonate-based resin (E), 50 to 70 parts by mass of a glass fiber-based reinforcing material (F), and 0.05 to 2 parts by mass of a transesterification inhibitor (G), relative to 100 parts by mass of a total of components (A), (B), (C), (D), (E) and (F), wherein glass fiber-based reinforcing material (F) comprises at least 40 to 55 parts by mass of a flat cross-section glass fiber (F1) having a ratio of major diameter to minor diameter (major diameter/minor diameter) of fiber cross-section of 1.3 to 8 and 5 to 20 parts by mass of a milled short glass fiber (F2) having a fiber length of 30 to 150 μm,

wherein glass fiber-based reinforcing material (F) in the inorganic material-reinforced thermoplastic polyester resin composition has a weight average fiber length Lw of 200 to 700 m, and

wherein the inorganic material-reinforced thermoplastic polyester resin composition has a melt viscosity of 0.6 kPa·s or more and 1.5 kPa·s or less at 270° C. and a shear rate of 10 sec⁻¹.

[2] The inorganic material-reinforced thermoplastic polyester resin composition according to item [1], having a crystallization temperature during cooling (TC2) in a range of: 160° C.≤TC2<180° C. as measured by differential scanning calorimetry (DSC).

[3] The inorganic material-reinforced thermoplastic polyester resin composition according to item [1] or [2], wherein an acid value of the resin component of the inorganic material-reinforced thermoplastic polyester resin composition is 5 to 50 eq/ton.

[4] The inorganic material-reinforced thermoplastic polyester resin composition according to any of items [1] to [3], wherein a number average fiber length Ln and a weight average fiber length Lw of glass fiber-based reinforcing material (F) in the inorganic material-reinforced thermoplastic polyester resin composition satisfy: 1.1≤Lw/Ln<2.4.

[5] A production method of the inorganic material-reinforced thermoplastic polyester resin composition according to any of items [1] to [4], comprising using a twin-screw extruder having a plurality of side feeders and separately feeding the same type of glass fiber-based reinforcing material (F) from the side feeders.

### Advantageous Effects of Invention

According to the present invention, the appearance of a molding formed from a resin composition even with addition of a large amount of glass fiber-based reinforcing material can be greatly improved by setting the solidification (crystallization) rate (TC2 as substitute measure) of the resin composition in a mold during cooling to a specific range, because the floating of glass fiber-based reinforcing material on the surface of the molding can be suppressed. Further, the resin composition containing a specific glass fiber-based reinforcing material in an amount in a specific range allows a molding having a good mirror surface appearance with high strength and high rigidity to be obtained without great increase in forming cycle, and also allows a jet black textured molding having a low gloss without texture irregularities, excellent in aesthetic quality, to be stably produced even in a long-time production.

### DESCRIPTION OF EMBODIMENTS

The embodiment of the present invention is described in detail as follows. The content of each component to constitute the inorganic material-reinforced thermoplastic polyester resin composition of the present invention is represented by part by mass relative to 100 parts by mass of a total of components (A), (B), (C), (D), (E) and (F).

With regards to the inorganic material-reinforced thermoplastic polyester resin composition of the present invention, the amount of each component blended as raw material (mass ratio) is directly the content (mass ratio) of each component in the inorganic material-reinforced thermoplastic polyester resin composition.

Polybutylene terephthalate resin (A) in the present invention is a resin as a main component among all polyester resins in the resin composition of the present invention. It is preferable that the content thereof be the highest among all polyester resins. Polybutylene terephthalate resin (A) is not particularly limited, and a homopolymer composed of terephthalic acid and 1,4-butanediol is preferably used. Further, relative to 100 mol % of the total acid components and 100 mol % of the total glycol components constituting polybutylene terephthalate resin (A), other components may be copolymerized up to about 5 mol % within a range not impairing moldability, crystallinity, surface gloss, etc. Examples of the other components include components used in copolymerized polybutylene terephthalate resin (C) described below.

For the molecular weight of polybutylene terephthalate resin (A), the reduced viscosity (0.1 g of a sample is dissolved in 25 mL of a mixed solvent of phenol/tetrachloroethane (mass ratio: 6/4) for measurement at 30° C. with use of an Ubbelohde viscosity tube) is preferably within the range of 0.5 to 0.7 dL/g, more preferably 0.6 to 0.7 dL/g. At a reduced viscosity of less than 0.5 dL/g, the toughness of the resin tends to greatly decrease, and burring tends to occur due to excessively high fluidity. On the other hand, at a reduced viscosity of more than 0.7 dL/g, it is difficult to apply uniform pressure to a textured molding due to the effect of reduced fluidity of the present composition, so that a good textured appearance is hardly obtained (molding conditions are narrowed).

The content of polybutylene terephthalate resin (A) is 8 to 20 parts by mass, preferably 10 to 20 parts by mass, and more preferably 13 to 18 parts by mass. With polybutylene terephthalate resin (A) blended in the range, various properties can be satisfied.

Polyethylene terephthalate resin (B) in the present invention is basically a homopolymer of ethylene terephthalate units. Further, relative to 100 mol % of the total acid components and 100 mol % of the total glycol components constituting polyethylene terephthalate resin (B), other components may be copolymerized up to about 5 mol % within a range not impairing various properties. Examples of the other components include components used in copolymerized polyethylene terephthalate resin (D) described below. Examples of the other components also include diethylene glycol produced by condensation of ethylene glycol during polymerization.

As the molecular weight of polyethylene terephthalate resin (B), the reduced viscosity (0.1 g of a sample is dissolved in 25 mL of a mixed solvent of phenol/tetrachloroethane (mass ratio: 6/4) for measurement at 30° C. with use of an Ubbelohde viscosity tube) is preferably within a range of 0.4 to 1.0 dL/g, more preferably 0.5 to 0.9 dL/g. At a reduced viscosity of less than 0.4 dL/g, the strength of the resin tends to decrease, and at a reduced viscosity of more than 1.0 dL/g, the fluidity of the resin tends to decrease.

The content of polyethylene terephthalate resin (B) is 1 to 7 parts by mass, preferably 2 to 7 parts by mass, and more preferably 3 to 6 parts by mass. With polyethylene terephthalate resin (B) blended in the range, various properties can be satisfied.

The copolymerized polybutylene terephthalate resin (C) in the present invention is a resin that contains 80 mol % or more of 1,4-butanediol and 120 to 180 mol % in total of terephthalic acid and 1,4-butanediol, based on 100 mol % in total of all the acid components and 100 mol % in total of all the glycol components. As a copolymerization component, at least one selected from the group consisting of isophthalic acid, sebacic acid, adipic acid, trimellitic acid, 2,6-naphthalenedicarboxylic acid, ethylene glycol, diethylene glycol, neopentyl glycol, 1,4-cyclohexanedimethanol, 1,2-propanediol, 1,3-propanediol, and 2-methyl-1,3-propanediol may be contained. In particular, isophthalic acid is preferred as a copolymerization component. Based on 100 mol % in total of all the acid components constituting copolymerized polybutylene terephthalate resin (C), the copolymerization ratio of isophthalic acid is preferably 20 to 80 mol %, more preferably 20 to 60 mol %. With a copolymerization ratio of less than 20 mol %, a satisfactory appearance may not be produced due to poor transferability to a mold, while with a copolymerization amount of more than 80 mol %, lowering of molding cycle and lowering of mold releasability may be caused.

As the molecular weight of copolymerized polybutylene terephthalate resin (C), the reduced viscosity (0.1 g of a sample is dissolved in 25 mL of a mixed solvent of phenol/tetrachloroethane (mass ratio: 6/4) for measurement at 30° C. with use of an Ubbelohde viscosity tube) is preferably 0.4 to 1.5 dL/g, more preferably 0.4 to 1.3 dL/g, though being slightly different depending on the specific copolymerization composition. At a reduced viscosity of less than 0.4 dL/g, the toughness tends to decrease, and at a reduced viscosity of more than 1.5 dL/g, the fluidity tends to decrease.

The content of copolymerized polybutylene terephthalate resin (C) is 1 to 12 parts by mass, preferably 2 to 10 parts by mass, more preferably 2 to 7 parts by mass, and still more preferably 3 to 6 parts by mass. With a content of less than 1 part by mass, appearance defects due to floating of glass fibers and mold transfer defects become conspicuous. With a content of more than 12 parts by mass, although the appearance of a molding is improved, the forming cycle is extended, which is unpreferable.

Copolymerized polyethylene terephthalate resin (D) in the present invention is a resin that contains 40 mol % or more of ethylene glycol and 80 to 180 mol % in total of terephthalic acid and ethylene glycol, based on 100 mol % in total of all the acid components and 100 mol % in total of all the glycol components. As a copolymerization component, at least one selected from the group consisting of isophthalic acid, sebacic acid, adipic acid, trimellitic acid, 2,6-naphthalenedicarboxylic acid, diethylene glycol, neopentyl glycol, 1,4-cyclohexanedimethanol, 1,4-butanediol, 1,2-propanediol, 1,3-propanediol and 2-methyl-1,3-propanediol may be contained. The copolymerized polyethylene terephthalate resin (D) is preferably amorphous. In particular, neopentyl glycol or a combination of neopentyl glycol and isophthalic acid is preferably used from the viewpoint of various characteristics as copolymerization component. It is preferable that the content of 1,4-butanediol as the copolymerization component be 20 mol % or less.

Based on 100 mol % in total of all the glycol components constituting the copolymerized polyethylene terephthalate resin (D), the copolymerization ratio of neopentyl glycol is preferably 20 to 60 mol %, more preferably 25 to 50 mol %.

Based on 100 mol % in total of all the acid components constituting copolymerized polyethylene terephthalate resin (D), the copolymerization ratio of isophthalic acid is preferably 20 to 60 mol %, more preferably 25 to 50 mol %.

As the molecular weight of copolymerized polyethylene terephthalate resin (D), the reduced viscosity (0.1 g of a sample is dissolved in 25 mL of a mixed solvent of phenol/tetrachloroethane (mass ratio: 6/4) for measurement at 30° C. with use of an Ubbelohde viscosity tube) is preferably 0.4 to 1.5 dL/g, more preferably 0.4 to 1.3 dL/g, though being slightly different depending on the specific copolymerization composition. At a reduced viscosity of less than 0.4 dug, the toughness tends to decrease, and at a reduced viscosity of more than 1.5 dL/g, the fluidity tends to decrease.

The content of copolymerized polyethylene terephthalate resin (D) is 5 to 12 parts by mass, preferably 6 to 12 parts by mass, and more preferably 7 to 10 parts by mass. With a content of less than 5 parts by mass, appearance defects due to floating of glass fibers become conspicuous. With a content of more than 12 parts by mass, although the appearance of a molding is improved, the forming cycle is extended, which is unpreferable.

The polycarbonate in polycarbonate-based resin (E) used in the present invention may be produced by a solvent method, that is, in the presence of a known acid acceptor and a molecular weight modifier in a solvent such as methylene chloride, by a reaction between a dihydric phenol and a carbonate precursor such as phosgene or by a transesterification between a dihydric phenol and a carbonate precursor such as diphenyl carbonate. As the dihydric phenols, bisphenols are preferably used, and 2,2-bis(4-hydroxyphenyl)propane, that is, bisphenol A is particularly preferred.

Alternatively, a part or all of bisphenol A may be replaced with another dihydric phenol. Examples of the dihydric phenol other than bisphenol A include compounds such as hydroquinone, 4,4-dihydroxydiphenyl and bis(4-hydroxyphenyl)alkane, and halogenated bisphenols such as bis(3,5-dibromo-4-hydroxyphenyl)propane and bis(3,5-dichloro-4-hydroxyphenyl)propane. The polycarbonate may be a homopolymer including one type of dihydric phenol or a copolymer including two or more types.

As polycarbonate-based resin (E), a resin consisting only of polycarbonate is preferably used. Polycarbonate-based resin (E) may be a resin obtained by copolymerizing a component other than polycarbonate (for example, a polyester component) within a range not impairing the effect of the present invention (20 mass % or less).

It is preferable that the polycarbonate resin (E) for use in the present invention has high fluidity, in particular. Ones having a melt volume rate (unit: cm³/10 min) measured under a load of 1.2 kg at 300° C. of 20 to 100 are preferably used, and the melt volume rate is more preferably 25 to 95, still more preferably 30 to 90. If one having a melt volume rate of less than 20 is used, the fluidity is significantly reduced, so that a decrease in strand stability and deterioration of moldability may be caused in some cases. At a melt volume rate of more than 100, deterioration of physical properties may be caused due to too low a molecular weight, and a problem such as gas generation tends to be caused by decomposition.

The content of polycarbonate-based resin (E) used in the present invention is 1 to 6 parts by mass, preferably 2 to 5 parts by mass. With a content of less than 1 part by mass, the effect for improving textured appearance is small. With a content of more than 6 parts by mass, the forming cycle is worsened resulting from lowered crystallinity and appearance defects tend to occur resulting from decrease in flowability, which is unpreferable.

As glass fiber-based reinforcing material (F) of the present invention, a milled fiber which is a short glass fiber having an average fiber diameter of about 4 to 20 μm and a cut length of about 30 to 150 μm, and a chopped strand having an average fiber diameter of about 1 to 20 μm and a cut fiber length of about 1 to 20 mm may be preferably used. As the cross-sectional shape of the glass fiber, a circular cross-section and a non-circular cross-section glass fiber may be used. As the glass fiber having a circular cross-sectional shape, a most common one having an average fiber diameter of about 4 to 20 μm and a cut length of about 2 to 6 mm may be used.

Examples of the glass fiber having a non-circular cross-section include ones having a cross-section perpendicular to the length direction of the fiber in an approximately elliptical shape, an approximately oval shape, or an approximately cocoon-like shape, which has a flatness of preferably 1.3 to 8. The flatness is defined as follows. A rectangle having the smallest area, which circumscribes a cross-section perpendicular to the longitudinal direction of the glass fiber, is assumed. The major diameter is the length of the long side of the rectangle, and the minor diameter is the length of the short side. The ratio of major diameter/minor diameter is the flatness. The thickness of the glass fiber is not particularly limited, and one having a minor diameter of 1 to 20 μm and a major diameter of about 2 to 100 μm may be used. One of these glass fibers may be used alone, or two or more thereof may be used in combination.

Glass fiber-based reinforcing material (F) is preferably a flat cross-section glass fiber (F1) having a ratio of the major diameter to the minor diameter (major diameter/minor diameter) of the fiber cross-section of 1.3 to 8 from the viewpoint of appearance and elastic modulus, or preferably a milled short glass fiber (F2) of having a fiber length of 30 to 150 μm from the viewpoint of suppressing glass floating. In the present invention, flat cross-section glass fiber (F) and milled short glass fiber (F2) are used in combination as glass fiber-based reinforcing material (F). On an as needed basis, a glass fiber having a circular cross-sectional shape may be further used.

The average fiber diameter and average fiber length of glass fibers may be measured through electron microscope observation.

As these glass fibers, those previously treated with a conventionally known coupling agent such as an organic silane compound, an organic titanium compound, an organic borane compound and an epoxy compound may be preferably used.

The inorganic material-reinforced thermoplastic polyester resin composition of the present invention may include an inorganic reinforcing material other than the glass fibers described above in combination, depending on the purpose in a range not impairing the properties. Specific examples thereof include mica, wallastonite, needle-shaped wallastonite, glass flakes and glass beads, which are generally commercially available, and may be used without problems even with treatment with a generally known coupling agent. In the case of using an inorganic reinforcing material other than glass fiber in combination, the content of glass fiber-based reinforcing material (F) is the total amount of glass fiber and other inorganic reinforcing materials, when considering the content of each component of the inorganic material-reinforced thermoplastic polyester resin composition of the present invention.

In the case of using glass fiber and other inorganic reinforcing material in combination, the content of glass fiber used in glass fiber-based reinforcing material (F) is preferably 50 mass % or more, more preferably 70 mass % or more, and still more preferably 80 mass % or more. However, as the inorganic reinforcing material, a material exhibiting a large effect as nucleating agent (for example, talc) is not preferable, because even a small amount thereof added causes deviation from the range of the crystallization temperature during cooling (TC2) of the material specified in the present invention.

The content of glass fiber-based reinforcing material (F) in the present invention is 50 to 70 parts by mass, preferably 60 to 67 parts by mass, and more preferably 62 to 66 parts by mass, from the viewpoint of rigidity and strength.

In this case, glass fiber-based reinforcing material (F) includes at least flat cross-section glass fiber (F1) having a ratio of the major diameter to the minor diameter (major diameter/minor diameter) of the fiber cross-section of 1.3 to 8 in an amount of 40 to 55 parts by mass and milled short glass fiber (F2) having a fiber length of 30 to 150 μm in an amount of 5 to 20 parts by mass. The content of flat cross-section glass fiber (F1) is preferably 42 to 53 parts by mass, more preferably 45 to 50 parts by mass, and the content of milled short glass fiber (F2) is preferably 10 to 18 parts by mass, more preferably 12 to 17 parts by mass.

The inorganic material-reinforced thermoplastic polyester resin composition of the present invention including each of flat cross-section glass fiber (F1) and milled short glass fiber (F2) as glass fiber-based reinforcing material (F) in the above range allows a molding obtained by injection molding of the inorganic material-reinforced thermoplastic polyester resin composition to have a Charpy impact strength of 20 kJ/m² or more. By setting glass fiber-based reinforcing material (F) to this composition ratio, it can be obtained a good appearance with high mechanical properties. The higher the Charpy impact strength is (in a range where the good appearance can be maintained), the better. The Charpy impact strength is preferably 22 kJ/m² or more.

As the name implies, the transesterification inhibitor (G) for use in the present invention is a stabilizer that prevents the transesterification reaction of a polyester resin.

In an alloy of polyester resins alone, transesterification occurs to not a small extent due to heat history, no matter how optimized the production conditions are. If it occurs to a very large extent, the desired characteristics of the alloy cannot be obtained. In particular, transesterification between polybutylene terephthalate and polycarbonate often occurs, and in that case, the crystallinity of polybutylene terephthalate is significantly reduced, which is not preferable. In the present invention, the addition of component (G) prevents particularly the transesterification between polybutylene terephthalate resin (A) and polycarbonate-based resin (E), so that a proper crystallinity can be maintained.

As the transesterification inhibitor (G), a phosphorus compound having a catalyst deactivation effect on the polyester resin may be preferably used, and for example, “ADEKA STAB AX-71” manufactured by ADEKA Corporation may be used.

The amount of transesterification inhibitor (G) added for use in the present invention is 0.05 to 2 parts by mass, preferably 0.1 to 1 part by mass. With a content of less than 0.05 parts by mass, the desired transesterification prevention performance may not be exhibited in many cases. To the contrary, even with an addition of more than 2 parts by mass, the effect is not improved so much, and may cause increases of gas in some cases.

The inorganic material-reinforced thermoplastic polyester resin composition of the present invention contains 50 to 70 parts by mass of glass fiber-based reinforcing material (F), so that a molding obtained by injection molding of the inorganic material-reinforced thermoplastic polyester resin composition can have a bending modulus of more than 20 GPa.

The inorganic material-reinforced thermoplastic polyester resin composition of the present invention has a crystallization temperature during cooling TC2 in a range of 160° C. or more and less than 180° C. as measured by differential scanning calorimetry (DSC). TC2 is the top temperature of crystallization peak of a thermogram obtained by heating to 300° C. at a heating rate of 20° C./min under a nitrogen stream, holding the temperature for 5 minutes, and then lowering the temperature to 100° C. at a rate of 10° C./min, using a differential scanning calorimeter (DSC). At TC2 of 180° C. or more, crystallization rate of the polyester resin composition increases, so that crystallization in the mold occurs quickly. The propagation speed of the injection pressure, therefore, tends to decrease particularly in a composition containing a large amount of inorganic reinforcing materials. As a result, due to insufficient adhesion between an injected product and the mold and the effect of shrinkage during crystallization, the inorganic reinforcing materials such as glass fiber stand out on the surface of the molding, which is so-called as glass fiber floating, to deteriorate the appearance of the molding. In that case, a method of delaying solidification of the molding by raising the mold temperature to a high temperature of 120 to 130° C. may be considered. Although the surface gloss and appearance are improved in the central portion where the injection pressure is high in the mold by the method, defects such as glass fiber floating are likely to occur in the end portion where injection pressure is hardly applied, so that it is difficult to obtain a uniformly good appearance. Further, since the temperature of the molding taken out from the mold is high, warp of the molding increases.

In contrast, in the case where TC2 is less than 160° C., the crystallization rate becomes too slow, and the slow crystallization may cause mold release failure due to sticking to the mold or deformation during extrusion in some cases. In addition, since the pressure during molding allows the resin to easily penetrate deeper into the texture, the texture may deviate during shrinkage of the resin in the mold or during mold release, resulting in non-uniform depth of the texture. It is therefore difficult to obtain a good textured appearance. In consideration of these concerns during molding, the inorganic material-reinforced thermoplastic polyester resin composition of the present invention is adjusted to have an optimum TC2, so that a good appearance and moldability may be obtained even at a mold temperature of 100° C. or less.

TC2 is more preferably 163° C. or more and 177° C. or less, still more preferably 165° C. or more and 175° C. or less.

Although TC2 may be adjusted by adjusting the contents of polyethylene terephthalate resin (B) and copolymerized polyethylene terephthalate resin (D), these components have a great influence on the shrinkage rate, the mold releasability, etc. Accordingly, there have been problems such as narrowed molding conditions in which a good appearance can be obtained even having TC2 within the target range through the adjustment described above, and deterioration of mold releasability even with achievement of a good appearance. It has been found that the inorganic material-reinforced thermoplastic polyester resin composition of the present invention has an extremely wide range of molding conditions to obtain a good appearance through adjustment of TC2 with a specific content of copolymerized polybutylene terephthalate resin (C), and molding is achieved without adversely affecting the other properties. According to the present invention, even from a composition including glass fiber-based reinforcing material (F) in an amount of more than 60 mass % in 100 mass % of the inorganic material-reinforced thermoplastic polyester resin composition, which is a composition allowing glass floating to occur extremely easily, a good appearance can be obtained in a wider range of molding conditions, due to the blending effect of copolymerized polybutylene terephthalate resin (C).

Accordingly, a good surface appearance may be obtained by molding the inorganic material-reinforced thermoplastic polyester resin composition of the present invention, at a mold temperature of about 90° C. in a wide range of injection rate under a wide range of molding conditions. In particular, an extremely jet-black molding having a uniform appearance without texture irregularity can be produced using a textured mold.

Here, weight average fiber length Lw of glass fiber-based reinforcing material (F) in the inorganic material-reinforced thermoplastic polyester resin composition of the present invention is 200 to 700 μm, preferably 230 to 700 μm, more preferably 300 to 700 μm, and still more preferably 500 to 700 μm. With weight average fiber length Lw in the above range, the mechanical strength is not so affected by the fiber length, and a molding having an excellent balance between mechanical properties and fluidity can be produced. In addition, a stable discharge pressure in the manufacturing process, and decrease in occurrence of clogging of glass fibers at the tip of the die, allow strand breakage to be suppressed. On the other hand, with Lw of less than 200 μm, the mechanical strength is lowered and burrs occur during molding along with decrease in the melt viscosity. Further, with Lw of more than 700 μm, the production stability is lowered and the dispersibility of the glass fibers in the resin composition is also lowered, so that variations in the quality such as mechanical strength, appearance, and warpage occur.

Further, it is preferable that number average fiber length Ln and weight average fiber length Lw of glass fiber-based reinforcing material (F) in the inorganic material-reinforced thermoplastic polyester resin composition in the present invention satisfy 1.0≤Lw/Ln≤2.4. Since a predetermined amount of milled short glass fiber (F2) is used, Lw/Ln of less than 1.1 means that the fiber length of flat cross-section glass fiber (F1) is shorter than necessary, which is not preferable. On the other hand, Lw/Ln of more than 2.4, the appearance of a molding tends to deteriorate. It is more preferable that Lw/Ln satisfies 1.2 or more and 2.3 or less.

The inorganic material-reinforced thermoplastic polyester resin composition of the present invention may contain various known additives on an as needed basis, within a range where properties in the present invention are not impaired. Examples of the known additives include a colorant such as a pigment, a mold release agent, a heat resistance stabilizer, an antioxidant, an ultraviolet absorber, a light stabilizer, a plasticizer, a modifier, an antistatic agent, a flame retardant, and a dye. These various additives may be contained in a total amount of up to 5 mass %, based on 100 mass % of the inorganic material-reinforced thermoplastic polyester resin composition. In other words, it is preferable that the total content of (A), (B), (C), (D), (E), (F) and (G) be 95 to 100 mass %, in 100 mass % of the inorganic material-reinforced thermoplastic polyester resin composition.

Examples of the mold release agent include a long-chain fatty acid or an ester thereof and a metal salt thereof, an amide compound, a polyethylene wax, silicon, and polyethylene oxide. As the long-chain fatty acid, one having 12 or more carbon atoms is particularly preferred, and examples thereof include stearic acid, 12-hydroxystearic acid, behenic acid, and montanic acid. A part or the whole of carboxylic acid may be esterified with monoglycol or polyglycol, or may form a metal salt. Examples of the amide compound include ethylene bis-terephthalamide and methylene bis-stearylamide. These mold release agents may be used alone or as a mixture.

The melt viscosity of the inorganic material-reinforced thermoplastic polyester resin composition of the present invention at 270° C. and a shear rate of 10 sec⁻¹ is 0.6 kPa·s or more and 1.5 kPa·s or less, preferably 0.7 kPa·s or more and 1.4 kPa·s or less, more preferably 0.8 kPa·s or more and 1.3 kPa·s or less. With a melt viscosity of less than 0.6 kPa·s, injection molding becomes difficult. On the other hand, with a melt viscosity of more than 1.3 kPa·s, burrs tend to occur in a molding. In order to satisfy the melt viscosity, it is important to formulate the composition as described above.

The acid value of the resin component contained in the inorganic material-reinforced polyester resin composition of the present invention is preferably 5 to 50 eq/ton. The acid value is related to the adhesiveness with glass fibers and the degree of gas generation during retention. Further, since the acid value affects the toughness of a molding, it is very important for a thin-walled and long molding. With the acid value of lower than 5 eq/ton, the adhesiveness with glass fibers is lowered, so that the toughness is lowered and the dispersibility of glass fibers in the resin composition is lowered, resulting in easy occurrence of quality variation. On the other hand, with the acid value of more than 50 eq/ton, gas is generated easily when the resin is retained at a high temperature, and the appearance of a molding tends to deteriorate. The acid value is more preferably 8 to 45 eq/ton.

A method for producing the inorganic material-reinforced thermoplastic polyester resin composition of the present invention may include mixing the above-mentioned components and, on an as needed basis, various stabilizers, pigments and the like, and melt-kneading the mixture. The melt-kneading method may be any method known to those skilled in the art with use of a single-screw extruder, a twin-screw extruder, a pressurizing kneader, a Banbury mixer, or the like. In particular, use of a twin-screw extruder is preferred. Typical melt-kneading conditions include a cylinder temperature of twin-screw extruder of 240 to 290° C., and a kneading time of 2 to 15 minutes.

Alternatively, only the glass fiber-based reinforcing material (F) or, on an as needed basis, other components may be supplied from a side feeder and melt-kneaded. For a screw element, a combination of a reverse disc and a kneading disc between the main feeder and the side feeder to melt the polyester resin by applying high shear is preferred. Further, it is preferable that the molten polyester resin be sent in a forward flight to be joined to the glass fiber-based reinforcing material (F) supplied from the side feeder for kneading in a low shear state. Subsequently, the molten polyester resin composition is extruded in a low shear state from the die and cooled with water to produce a strand of the polyester resin composition. The resulting polyester resin composition is vacuum dried, for example, under conditions at 80° C. for 12 hours, and then molded to produce a molding.

In the method for producing the inorganic material-reinforced thermoplastic polyester resin composition of the present invention, it is preferable that the same type of glass fiber-based reinforcing material (F) be separately fed into a twin-screw extruder from different feeders.

Further, in the present invention, side feeders may be provided at a plurality of places. The fiber length of the glass fiber-based reinforcing material (F) supplied from the upstream side feeder is shorter than the fiber length of the glass fiber-based reinforcing material (F) supplied from the downstream side feeder. By changing the amount of the glass fiber-based reinforcing material (F) supplied to each side feeder, the fiber length in the composition is easily adjusted to a predetermined range without changing other extrusion conditions. Incidentally, compared with the method of supplying from an original feeder (main feeder) and one side feeder, the above method is preferred because it is easier to control the fiber length distribution.

The position of the side feeder that supplies the glass fiber-based reinforcing material (F) may be optionally adjusted according to the aim such as the amount of the glass fiber-based reinforcing material (F), the ease of mixing with the resin, and the fiber length of the reinforcing material. In the production of the inorganic material-reinforced thermoplastic polyester resin composition of the present invention, it is preferable that a first side feeder be provided behind a quarter of the distance from the main feeder to the die from the main feeder, such that the fiber length is not shortened too much. For example, in the case of a twin-screw extruder TEM75BS having 12 barrels (manufactured by Shibaura Machine Co., Ltd., number of barrels: 12, screw diameter: 75 mm, L/D=45), it is preferable that a main feeder be disposed at a first barrel, and first side feeder be installed at a fourth to seventh barrel and a second side feeder be installed at an eighth to eleventh barrel for easy adjustment of the fiber length. For example, milled short glass fiber (F2) is fed from the first side feeder, and flat cross-section glass fiber (F1) is fed from the first side feeder and the second side feeder at a mass ratio of 40/60 to 70/30, respectively, so that the fiber length can be easily adjusted to a preferable length.

In other words, in the production method of the inorganic material-reinforced thermoplastic polyester resin composition of the present invention, it is preferable to use a twin-screw extruder having a plurality of side feeders, such that the same type of glass fiber-based reinforcing material (F) is dividedly fed from the plurality of side feeders. On this occasion, it is preferable that the glass fiber-based reinforcing material (F) be fed only from a plurality of side feeders, without being fed from the main feeder.

The inorganic material-reinforced thermoplastic polyester resin composition of the present invention can be made into a molding by a known molding method. The molding method is not specified, and injection molding, blow molding, extrusion molding, foam molding, malformed molding, calendar molding, and various other molding methods may be preferably used. In particular, injection molding is preferred.

### EXAMPLES

The present invention will be more specifically described with reference to Examples, though the present invention is not limited thereto. The measured values shown in the Examples were measured by the following methods, respectively.

(1) Reduced viscosity of polyester resin:

In 25 mL of a mixed solvent of phenol/tetrachloroethane (mass ratio: 6/4), 0.1 g of a sample was dissolved and measured at 30° C. using an Ubbelohde viscosity tube (unit:dL/g).

(2) Crystallization temperature during cooling (TC2):

Using a differential scanning calorimeter (DSC), the top temperature of crystallization peak of a thermogram was obtained by heating to 300° C. at a heating rate of 20° C./min under a nitrogen stream, holding the temperature for 5 minutes, and then lowering the temperature to 100° C. at a rate of 10° C./min.

(3) Appearance of mirror surface of molding

When molding a strip shaped molding having a width of 18 mm, a length of 180 mm and a thickness of 2 mm at a cylinder temperature of 275° C. and a mold temperature of 90° C. by injection molding, the appearances of a molding A molded in an injection speed range with a filling time of 1 second (molding condition A) and a molding B molded in an injection speed range with a filling time of 2.2 seconds (molding condition B) were visually observed. Incidentally, the dwell pressure was set to 75 MPa. “O” and “Δ” are at a level causing no particular problems.

O: Good appearance with no appearance defect such as floating of glass fiber.

Δ: In a part (particularly at an end of a molding), some appearance defects occur.

X: Appearance defects occur on the whole of molding.

(4) Textured appearance of molding

The textured appearance of a molding molded under the conditions described in the above (3) was visually observed. The texture was made by using a textured mold having a matte surface with a depth of 15 μm. “O” and “Δ” are at a level causing no particular problems.

O: Good appearance with no appearance defect caused by displacement of the texture at all.

Δ: In a very small part of a molding, some appearance defects caused by displacement of the texture occur, and a white part can be identified through observation from a different angle.

X: Appearance defects caused by displacement of the texture occur on the whole of molding, a white part can be identified through observation from a different angle.

(5) Mold releasability

In molding under the conditions described in the above (3), the cooling time after completion of the injection step was set to 5 seconds to determine the mold releasability (total molding cycle: 17 seconds). “O” and “A” are at a level causing no particular problems.

O: Continuous molding is easily performed without problem of mold releasability.

Δ: Continuous molding is possible, though mold release failure occurs once in several shots.

X: Continuous molding is impossible due to occurrence of mold release failure in every shot.

(6) Amount of burr generated

The maximum value of the burr at the flow end portion generated in the molding A molded under the conditions described in the above (3) was measured using a microscope.

(7) Bending strength and bending fracture strain

The measurement was performed in accordance with ISO-178. The test piece was injection molded under the conditions at a cylinder temperature of 265° C. and a mold temperature of 90° C.

(8) Charpy impact strength

The measurement was performed in accordance with ISO-179. The test piece was injection molded under the conditions at a cylinder temperature of 265° C. and a mold temperature of 90° C.

(9) Number average fiber length and weight average fiber length:

The residual glass fiber length in the inorganic material-reinforced thermoplastic polyester resin composition was measured by the following method.

In a material highly filled with glass fibers, glass fibers are easily damaged during measurement due to a lot of interference among the glass fibers, so that the accurate fiber length is hardly obtained. Therefore, in the present invention, a pellet obtained by melt-kneading for accurate measurement of the glass fiber length was ignited at 650° C. for 2 hours for extraction of the glass fibers as ash without damaging the glass fibers. The resulting glass fibers were immersed in water, and the dispersed glass fibers were taken out on a preparation. Randomly selected 1000 or more pieces of glass fibers were observed at a magnification power of 80 with a digital microscope (KH-7700 manufactured by Hirox Co., Ltd.) to determine the number average fiber length and the weight average fiber length, respectively. Weight average fiber length (Lw) may be calculated by the following equation, wherein (Ni) is the number of fibers having circumference ratio (n), fiber length (Li), density (ρi), and fiber diameter (ii).

Lw=Σ(Ni×π×ri²×Li²×ρi)/Σ(Ni×πri²×Li×ρi)

In the case where the fiber diameter and density are constant, Lw may be calculated by the following equation.

Lw=Σ(Ni×Li²)/Σ(Ni×Li)

(10) Melt Viscosity

By using Capillograph 1B manufactured by Toyo Seiki Seisaku-sho, Ltd., the melt viscosity of the resin composition in a pellet shape was measured at a shear rate of 10 sec⁻¹ and a furnace temperature of 270° C. with use of a capillary having an inner diameter ϕ of 1 mm and a length L of 30 mm in accordance with ISOI 1443.

(11) Acid value

Acid value of polyester resin:

In 25 ml of benzyl alcohol, 0.5 g of polyester resin was dissolved and titrated using a benzyl alcohol solution having a concentration of sodium hydroxide of 0.01 mol/l. The indicator used was 0.10 g of phenolphthalein dissolved in a mixture of 50 mL of ethanol and 50 mL of water.

Acid value of resin component in resin composition:

In 25 ml of benzyl alcohol, 0.5 g of the resin composition was dissolved and titrated using a benzyl alcohol solution having a sodium hydroxide concentration of 0.01 mol/l. The indicator used was 0.10 g of phenolphthalein dissolved in a mixture of 50 mL of ethanol and 50 mL of water. In measurement of the above “(9) Number average fiber length and weight average fiber length”, the mass of the inorganic material-reinforced thermoplastic polyester resin composition and the mass of the ash content were measured and converted into the content per mass of the resin component contained in the resin composition.

(12) Strand breakage

The number of strand breakages that had occurred during pellet production performed continuously for 24 hours was evaluated based on the following criteria.

O: Less than 10 times.

X: 10 times or more.

The components blended used in Examples and Comparative Examples are as follows.

[Polybutylene terephthalate resin (A)]

(A1) Polybutylene terephthalate:

Manufactured by Toyobo Co., Ltd., reduced viscosity: 0.58 dl/g, acid value: 24 eq/ton

(A2) Polybutylene terephthalate:

Manufactured by Toyobo Co., Ltd., reduced viscosity: 0.58 dl/g, acid value: 104 eq/ton

(A3) Polybutylene terephthalate:

Manufactured by Toyobo Co., Ltd., reduced viscosity: 0.58 dl/g, acid value: 4 eq/ton

(A4) Polybutylene terephthalate:

Manufactured by Toyobo Co., Ltd., reduced viscosity: 0.58 dl/g, acid value: 126 eq/ton

[Polyethylene terephthalate resin (B)]

(B) Polyethylene terephthalate:

Manufactured by Toyobo Co., Ltd., reduced viscosity: 0.63 dl/g, acid value: 20 eq/ton

[Copolymedzed polybutylene terephthalate resin (C)]

(C1) Copolymerized polybutylene terephthalate: Copolymer with composition ratio TPA/IPA//1,4-BD=70/30//100 (mol %), manufactured by Toyobo Co., Ltd., prototype of Toyobo Vylon (registered trademark), reduced viscosity: 0.73 dl/g, acid value: 8 eq/ton

(C2) Copolymerized polybutylene terephthalate: Copolymer with composition ratio TPA/IPA//1,4-BD=45/55//100 (mol %), manufactured by Toyobo Co., Ltd., prototype of Toyobo Vylon (registered trademark), reduced viscosity: 0.76 dl/g, acid value: 7 eq/ton

[Copolymerized polyethylene terephthalate resin (D)]

(D1) Copolymerized polyethylene terephthalate:

Copolymer with composition ratio TPA//EG/NPG=100//70/30 (mol %), manufactured by Toyobo Co., Ltd., a prototype of Toyobo Vylon (registered trademark), reduced viscosity 0.83 dl/g, acid value: 6 eq/ton

(D2) Copolymerized polyethylene terephthalate:

Copolymer with composition ratio TPA/IPA//EG/NPG=50/50//50/50 (mol %), manufactured by Toyobo Co., Ltd., a prototype of Toyobo Vylon (registered trademark), reduced viscosity: 0.53 dl/g, acid value: 10 eq/ton

(The abbreviations indicate the following components, respectively. TPA: terephthalic acid, IPA: isophthalic acid, 1,4-BD: 1,4-butanediol, EG: ethylene glycol, NPG: neopentyl glycol)

[Polycarbonate-based resin (E)]

(E1) Polycarbonate: “CALIBRE 301-40” manufactured by Sumika Styron Polycarbonate Ltd., melt volume rate (300° C., load: 1.2 kg): 40 cm³/10 min

[Glass fiber-based reinforcing material (F)]

(Fiber diameter and fiber length are measured values through electron microscope observation)

(F1) Flat cross-section glass fiber: “CSG3PL830S” manufactured by Nitto Boseki Co., Ltd., flat cross-section, ratio of major diameter to minor diameter: 2 (minor diameter: 10 μm, major diameter: 20 μm), average fiber length: 3 mm

(F2) Milled short glass fiber: “EFH-100-31” manufactured by Central Glass Fiber Co., Ltd., milled fiber (silane treatment), average fiber length: 100 μm, average fiber diameter: 11 μm

(G) Transesterification inhibitor:

“ADEKA STAB AX-71” manufactured by ADEKA Corporation

In preparation of the inorganic material-reinforced thermoplastic polyester compositions of Examples and Comparative Examples, the above raw materials were weighed according to the blending ratio (parts by mass) shown in Table 1, and melt-kneaded with a twin-screw extruder TEM75BS (manufactured by Shibaura Machine Co., Ltd., number of barrels: 12, screw diameter: 75 mm, L/D=45) having a main feeder disposed at a first barrel from the upstream side of the extruder, a first side feeder disposed at a fifth barrel, and a second side feeder at a ninth barrel, at a cylinder temperature of 270° C. and a screw rotation speed of 200 rpm. The raw materials other than glass fiber-based reinforcing material (F) were fed into the twin-screw extruder from a hopper (main feeder), and glass fiber-based reinforcing material (F) was fed from each of the feeders shown in Table 1. The number of strand breakages in continuous production for 24 hours was checked. The resulting pellets of the inorganic material-reinforced thermoplastic polyester resin composition were dried, and then molded into evaluation samples for various evaluations by an injection molding machine. The evaluation results are shown in Table 1.

TABLE 1

| | | Example | Example | Example | Example | Example | Example | Example | Example | Example | Example |
|---|---|---|---|---|---|---|---|---|---|---|---|
| | Type | 1 | 2 | 3 | 4 | 5 | 6 | 7 | 8 | 9 | 10 |
| Composition | (A1) Polybutylene | 16 | 16 | 16 | | | 16 | 16 | 14 | | 16 |
| | terephthalate | | | | | | | | | | |
| | (A2) Polybutylene | | | | 16 | | | | | | |
| | terephthalate | | | | | | | | | | |
| | (A3) Polybutylene | | | | | 16 | | | | | |
| | terephthalate | | | | | | | | | | |
| | (A4) Polybutylene | | | | | | | | | 16 | |
| | terephthalate | | | | | | | | | | |
| | (B) Polyethylene | 5 | 5 | 5 | 5 | 5 | 5 | 5 | 4 | 5 | 5 |
| | terephthalate | | | | | | | | | | |
| | (C1) Copolymerized | | | | | | 4 | | | | |
| | polybutylene | | | | | | | | | | |
| | terephthalate | | | | | | | | | | |
| | (C2) Copolymerized | 4 | 4 | 4 | 4 | 4 | | 4 | 6 | 4 | 4 |
| | polybutylene | | | | | | | | | | |
| | terephthalate | | | | | | | | | | |
| | (D1) Copolymerized | 9 | 9 | 9 | 9 | 9 | 9 | | 7 | 9 | 9 |
| | polyethylene | | | | | | | | | | |
| | terephthalate | | | | | | | | | | |
| | (D2) Copolymerized | | | | | | | 9 | | | |
| | polyethylene | | | | | | | | | | |
| | terephthalate | | | | | | | | | | |
| | (E1) Polycarbonate | 3 | 3 | 3 | 3 | 3 | 3 | 3 | 3 | 3 | 3 |
| | (F1) Flat cross- | 48 | 48 | 48 | 48 | 48 | 48 | 48 | 49 | 48 | 48 |
| | section glass fiber | | | | | | | | | | |
| | (F2) Milled short | 15 | 15 | 15 | 15 | 15 | 15 | 15 | 17 | 15 | 15 |
| | glass fiber | | | | | | | | | | |
| | (G) | 0.15 | 0.15 | 0.15 | 0.15 | 0.15 | 0.15 | 0.15 | 0.15 | 0.15 | 0.15 |
| | Transesterification | | | | | | | | | | |
| | inhibitor | | | | | | | | | | |
| Supply of | Main feeder | | 30 | | | | | | | | 30 |
| (F1) | First side feeder | 30 | 18 | 23 | 30 | 30 | 30 | 30 | 30 | 30 | |
| | Second side feeder | 18 | | 25 | 18 | 18 | 18 | 18 | 19 | 18 | 18 |
| Supply of | First side feeder | | 15 | 15 | 15 | 15 | | | | | |
| (F2) | Second side feeder | 15 | | | | | 15 | 15 | 17 | 15 | 15 |
| Properties | Number average fiber | 494 | 140 | 530 | 496 | 492 | 494 | 494 | 488 | 155 | 147 |
| | length Ln [μm] | | | | | | | | | | |
| | Weight average fiber | 630 | 240 | 695 | 636 | 628 | 630 | 630 | 620 | 340 | 410 |
| | length Lw [μm] | | | | | | | | | | |
| | Lw/Ln | 1.3 | 1.7 | 1.3 | 1.3 | 1.3 | 1.3 | 1.3 | 1.3 | 2.2 | 2.8 |
| | Acid value of resin | 14 | 14 | 14 | 45 | 8 | 14 | 14 | 14 | 55 | 14 |
| | component [eq/ton] | | | | | | | | | | |
| | Melt viscosity | 1.0 | 0.8 | 1.1 | 0.7 | 1.2 | 0.9 | 0.9 | 0.8 | 0.6 | 0.8 |
| | (270° C., 10 sec⁻¹) | | | | | | | | | | |
| | [kPa · s] | | | | | | | | | | |
| | Crystallization | 172 | 172 | 172 | 171 | 173 | 176 | 176 | 172 | 165 | 172 |
| | temperature during | | | | | | | | | | |
| | cooling [° C.] | | | | | | | | | | |
| | Strand breakage | ○ | ○ | ○ | ○ | ○ | ○ | ○ | ○ | ○ | ○ |
| | Bending strength | 305 | 292 | 306 | 304 | 302 | 307 | 310 | 302 | 299 | 295 |
| | [MPa] | | | | | | | | | | |
| | Bending fracture | 1.2 | 1.1 | 1.2 | 1.3 | 1.2 | 1.2 | 1.2 | 1.2 | 1.1 | 1.1 |
| | strain [%] | | | | | | | | | | |
| | Charpy impact | 26 | 25 | 26 | 26 | 27 | 26 | 26 | 26 | 25 | 25 |
| | strength [kJ/m²] | | | | | | | | | | |
| | Mold releasability | ○ | ○ | ○ | ○ | ○ | ○ | ○ | ○ | Δ | ○ |
| | Amount of burr [mm] | 0.12 | 0.12 | 0.10 | 0.14 | 0.09 | 0.12 | 0.12 | 0.12 | 0.20 | 0.12 |
| | Molding A, | ○ | ○ | ○ | ○ | ○ | ○ | ○ | ○ | ○ | ○ |
| | appearance of mirror | | | | | | | | | | |
| | surface | | | | | | | | | | |
| | Molding A, | ○ | ○ | ○ | ○ | ○ | ○ | ○ | ○ | ○ | ○ |
| | appearance of | | | | | | | | | | |
| | textured surface | | | | | | | | | | |
| | Molding B, | ○ | ○ | ○ | ○ | ○ | ○ | ○ | ○ | Δ | Δ |
| | appearance of mirror | | | | | | | | | | |
| | surface | | | | | | | | | | |
| | Molding B, | ○ | ○ | ○ | ○ | ○ | ○ | ○ | ○ | Δ | Δ |
| | appearance of | | | | | | | | | | |
| | textured surface | | | | | | | | | | |

| | | Comparative | Comparative | Comparative | Comparative | Comparative |
|---|---|---|---|---|---|---|
| | Type | Example 1 | Example 2 | Example 3 | Example 4 | Example 5 |
| Composition | (A1) Polybutylene | 16 | 16 | 16 | 20 | 16 |
| | terephthalate | | | | | |
| | (A2) Polybutylene | | | | | |
| | terephthalate | | | | | |
| | (A3) Polybutylene | | | | | |
| | terephthalate | | | | | |
| | (A4) Polybutylene | | | | | |
| | terephthalate | | | | | |
| | (B) Polyethylene | 5 | 5 | 5 | 5 | 5 |
| | terephthalate | | | | | |
| | (C1) Copolymerized | | | | | |
| | polybutylene | | | | | |
| | terephthalate | | | | | |
| | (C2) Copolymerized | 4 | 4 | 4 | | 4 |
| | polybutylene | | | | | |
| | terephthalate | | | | | |
| | (D1) Copolymerized | 9 | 9 | 9 | 9 | 9 |
| | polyethylene | | | | | |
| | terephthalate | | | | | |
| | (D2) Copolymerized | | | | | |
| | polyethylene | | | | | |
| | terephthalate | | | | | |
| | (E1) Polycarbonate | 3 | 3 | 3 | 3 | 3 |
| | (F1) Flat cross- | 48 | 48 | 48 | 48 | 48 |
| | section glass fiber | | | | | |
| | (F2) Milled short | 15 | 15 | 15 | 15 | 15 |
| | glass fiber | | | | | |
| | (G) | 0.15 | 0.15 | 0.15 | 0.15 | |
| | Transesterification | | | | | |
| | inhibitor | | | | | |
| Supply of | Main feeder | 35 | | 12 | | |
| (F1) | First side feeder | 13 | 18 | | 18 | 18 |
| | Second side feeder | | 30 | 36 | 30 | 30 |
| Supply of | First side feeder | 15 | 15 | 15 | 15 | |
| (F2) | Second side feeder | | | | | 15 |
| Properties | Number average fiber | 105 | 560 | 280 | 558 | 560 |
| | length Ln [μm] | | | | | |
| | Weight average fiber | 180 | 745 | 710 | 748 | 745 |
| | length Lw [μm] | | | | | |
| | Lw/Ln | 1.7 | 1.3 | 2.5 | 1.3 | 1.3 |
| | Acid value of resin | 14 | 14 | 14 | 15 | 14 |
| | component [eq/ton] | | | | | |
| | Melt viscosity | 0.5 | 1.7 | 1.6 | 1.7 | 1.7 |
| | (270° C., 10 sec⁻¹) | | | | | |
| | [kPa · s] | | | | | |
| | Crystallization | 172 | 172 | 172 | 181 | 159 |
| | temperature during | | | | | |
| | cooling [° C.] | | | | | |
| | Strand breakage | ○ | X | X | X | ○ |
| | Bending strength | 247 | 314 | 310 | 312 | 311 |
| | [MPa] | | | | | |
| | Bending fracture | 0.8 | 1.4 | 1.4 | 1.4 | 1.4 |
| | strain [%] | | | | | |
| | Charpy impact | 22 | 28 | 28 | 28 | 28 |
| | strength [kJ/m²] | | | | | |
| | Mold releasability | ○ | ○ | ○ | ○ | X |
| | Amount of burr [mm] | 0.31 | 0.12 | 0.12 | 0.12 | 0.12 |
| | Molding A, | ○ | Δ | X | X | Δ |
| | appearance of mirror | | | | | |
| | surface | | | | | |
| | Molding A, | ○ | Δ | X | X | X |
| | appearance of | | | | | |
| | textured surface | | | | | |
| | Molding B, | ○ | X | X | X | X |
| | appearance of mirror | | | | | |
| | surface | | | | | |
| | Molding B, | ○ | X | X | X | X |
| | appearance of | | | | | |
| | textured surface | | | | | |

As shown in Table 1, in Examples 1 to 10 within the scope of the present invention, the molding had an appearance at a level causing no problems in any of molding conditions A and B, regardless of whether the molding had a mirror surface or a textured surface. In particular, in Examples 1 to 8, since the acid value and Lw/Ln of the resin components of the resin composition satisfied the specific ranges, the molding had a good appearance in any of the molding conditions A and B, regardless of whether the molding had a mirror surface or a textured surface, and further had high bending strength and high Charpy impact strength. On the other hand, in Comparative Example 1, the bending strength and the Charpy impact strength were low due to Lw out of the lower limit, and the amount of burrs was large due to the melt viscosity out of the range. In Comparative Examples 2 to 5, the fluidity of the resin composition is insufficient due to Lw out of the upper limit, so that the molding had poor appearance.

In addition, discharging was unstable due to easy clogging of the glass fibers in the die head during production, so that strand breakages occurred easily. In particular, in Comparative Example 3 with Lw/Ln of more than 2.4, and in Comparative Example 4 with a crystallization temperature during cooling of more than 180° C., the appearance deterioration was remarkable, and in Comparative Example 5 with a crystallization temperature during cooling of less than 160° C., the mold releasability deteriorated.

### INDUSTRIAL APPLICABILITY

According to the present invention, a molding having high strength and high rigidity with a good surface appearance is stably obtained under wide molding conditions. The present invention therefore contributes to industrial applications.

1. An inorganic material-reinforced thermoplastic polyester resin composition, comprising 8 to 20 parts by mass of a polybutylene terephthalate resin (A), 1 to 7 parts by mass of a polyethylene terephthalate resin (B), 1 to 12 parts by mass of a copolymerized polybutylene terephthalate resin (C), 5 to 12 parts by mass of a copolymerized polyethylene terephthalate resin (D), 1 to 6 parts by mass of a polycarbonate-based resin (E), 50 to 70 parts by mass of a glass fiber-based reinforcing material (F), and 0.05 to 2 parts by mass of a transesterification inhibitor (G), relative to 100 parts by mass of a total of components (A), (B), (C), (D), (E) and (F),
wherein glass fiber-based reinforcing material (F) comprises at least 40 to 55 parts by mass of a flat cross-section glass fiber (F1) having a ratio of major diameter to minor diameter (major diameter/minor diameter) of fiber cross-section of 1.3 to 8 and 5 to 20 parts by mass of a milled short glass fiber (F2) having a fiber length of 30 to 150 μm,
wherein glass fiber-based reinforcing material (F) in the inorganic material-reinforced thermoplastic polyester resin composition has a weight average fiber length Lw of 200 to 700 μm, and
wherein the inorganic material-reinforced thermoplastic polyester resin composition has a melt viscosity of 0.6 kPa·s or more and 1.5 kPa·s or less at 270° C. and a shear rate of 10 sec⁻¹.

2. The inorganic material-reinforced thermoplastic polyester resin composition according to claim 1, having a crystallization temperature during cooling (TC2) in a range of: 160° C.≤TC2<180° C. as measured by differential scanning calorimetry (DSC).

3. The inorganic material-reinforced thermoplastic polyester resin composition according to claim 1, wherein an acid value of the resin component of the inorganic material-reinforced thermoplastic polyester resin composition is 5 to 50 eq/ton.

4. The inorganic material-reinforced thermoplastic polyester resin composition according to claim 1, wherein a number average fiber length Ln and a weight average fiber length Lw of glass fiber-based reinforcing material (F) in the inorganic material-reinforced thermoplastic polyester resin composition satisfy: 1.1≤Lw/Ln≤2.4.

5. A production method of the inorganic material-reinforced thermoplastic polyester resin composition according to claim 1, comprising using a twin-screw extruder having a plurality of side feeders and separately feeding the same type of glass fiber-based reinforcing material (F) from the side feeders.
